(19) United States
(12) Patent Application Publication
(10) Pub. No.: US 2005/0262390 A1
(43) Pub. Date: Nov. 24, 2005

(54) Method and apparatus for constructing redundant array of independent disks system using disk drives

(75) Inventors: Yutaka Okamoto, Chofu-shi (JP); Shuichi Kojima, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/099,608

(22) Filed: Apr. 6, 2005

(30) Foreign Application Priority Data
Apr. 28, 2004 (JP) 2004-134497

(51) Int. Cl. G06F 11/00

(52) U.S. Cl. 714/6

(57) ABSTRACT

A disk drive includes a controller into which a function of constructing a RAID system in collaboration with other disk drives is incorporated. The controller is also singularly operated. The controller is operated as a RAID controller based on a command from a host system.

### CROSS-REFERENCE TO RELATED APPLICATIONS

This application is based upon and claims the benefit of priority from prior Japanese Patent Application No. 2004-134497, filed Apr. 28, 2004, the entire contents of which are incorporated herein by reference.

### BACKGROUND OF THE INVENTION

1. Field of the Invention

The present invention relates to a method and apparatus for constructing a RAID (Redundant Array of Independent Disks) system formed by plural disk drives.

2. Description of the Related Art

Conventionally, a disk storage system called a redundant array of independent disks (RAID) system or a disk array system is well known. When compared with the single disk drive, the RAID system can realize disk storage device having large storage capacity and high reliability.

However, a dedicated control device called a RAID controller (disk array controller) is required for the RAID system. When compared with the case where the plural disk drives are used, the RAID system becomes a large-scale and complicated configuration.

A method of constructing the RAID system without using the RAID controller is proposed in a prior art (for example, see Jpn. Pat. Appln. KOKAI Publication No. 2003-99210). In the method, the so-called virtual RAID system is realized by utilizing the disk drives respectively connected to the plural computers constituting a clustering system.

In the method of the prior art, since the RAID system is constructed by utilizing the plural computers to realize the RAID controller function, the total system becomes the large-scale and complicated configuration.

### BRIEF SUMMARY OF THE INVENTION

In accordance with an aspect of the present invention, there is provided a disk drive including a facility to construct the RAID system in collaboration with other disk drives.

The disk drive comprises: a drive mechanism which is operated as a single disk drive; a communication unit which exchanges information for constructing a RAID system with other disk drives; and a controller which exchanges information with other disk drives by using the communication unit, the controller realizing the RAID system by controlling the drive mechanism and drive mechanisms of other disk drives.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a RAID system according to a first embodiment of the invention;

FIG. 2 is a block diagram showing a main part of a disk drive according to the first embodiment;

FIG. 3 is a view showing the configuration of a distributed RAID table according to the first embodiment;

FIG. 4 is a view showing the configuration of a RAID structure table according to the first embodiment;

FIGS. 5, 6, 7A, and 7B are a flowchart for explaining constructing operation of the RAID system according to the first embodiment;

FIGS. 8A to 8C and 9A to 9C are a view for explaining a block structure of each disk drive according to the first embodiment;

FIGS. 10A and 10B are a view for explaining the constructing operation of the RAID system which is applied to a RAID type 1 in the first embodiment;

FIGS. 11 to 14 are a flowchart for explaining a first specific example of data reading operation according to the first embodiment;

FIGS. 15, 16, 17A, 17B, and 18 are a flowchart for explaining a second specific example of the data reading operation according to the second embodiment;

FIGS. 19 and 20 are a flowchart for explaining a third specific example of the data reading operation according to the third embodiment;

FIGS. 21 to 24 are a flowchart for explaining a first specific example of data writing operation according to the first embodiment;

FIGS. 25, 26, 27A, 27B, and 28 are a flowchart for explaining a second specific example of the data writing operation according to the second embodiment;

FIGS. 29 and 30 are a flowchart for explaining a third specific example of the data writing operation according to the third embodiment;

FIG. 31 is a block diagram showing the configuration of the RAID system according to a second embodiment;

FIG. 32 is a block diagram showing the configuration of the RAID system according to a third embodiment;

FIG. 33 is a view showing a format of a communication packet according to the third embodiment;

FIG. 34 is a flowchart showing a RAID constructing procedure according to the third embodiment; and

FIG. 35 is a flowchart showing a communication procedure between disk drives according to the third embodiment.

### DETAILED DESCRIPTION OF THE INVENTION

Referring now to the accompanying drawings, embodiments of the invention will be described.

### First Embodiment

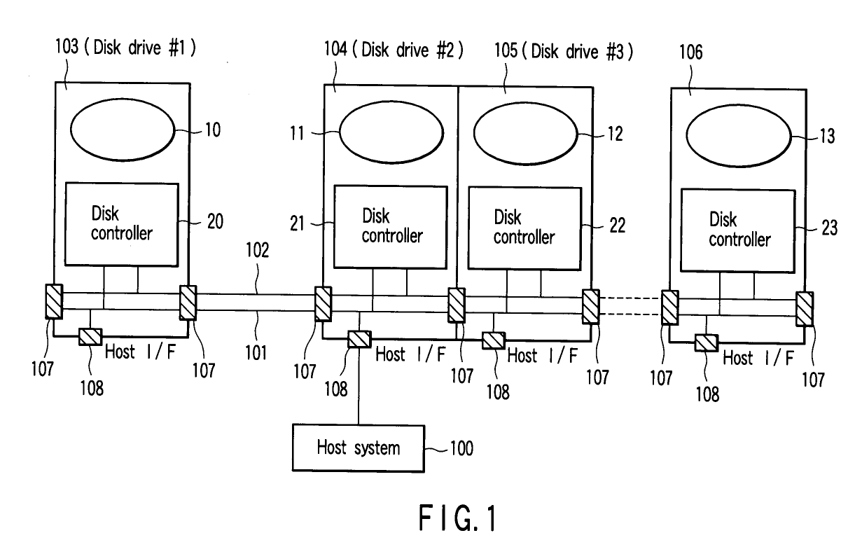

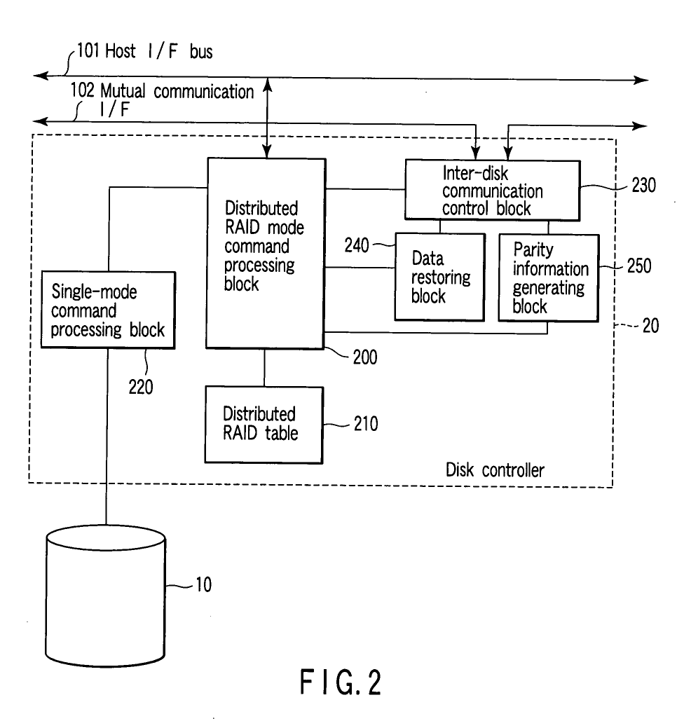

FIG. 1 is a block diagram showing a system configuration of the RAID system according to a first embodiment. FIG. 2 is a block diagram showing a main part of each disk drive.

(System Configuration)

In the first embodiment, each of plural disk drives 103 to 106 has a drive mechanism which is separately operated. The drive mechanisms include disk media 10 to 13 and disk controllers 20 to 23 respectively. As mentioned later, each of the disk controllers 20 to 23 has a function of constructing the RAID system. For the sake of convenience, sometimes the disk drives 103 to 105 are referred to as disk drives #1 to #3.

The disk drives 103 to 106 are connected to a host system 100 through a host interface bus 101. As with interface specifications such as ATA and SCSI, the host interface bus 101 includes physical specifications and command system for controlling the disk drive. For example, the physical specifications include a pin arrangement and a signal level by which the disk drives 103 to 106 are separately controlled from the host system 100 to perform data write/read.

The host interface bus 101 also has a command system in which the disk drives 103 to 106 mutually collaborate with one another to construct the RAID system. Like the conventional interface, it is possible that a connector on the disk drive side of the host bus interface is provided in each of the disk drives 103 to 106.

In the first embodiment, each of the disk drives 103 to 106 includes a connector 107 used for the connection between the disk drives and a connector 108 used for the connection to the host system 100. In the connector 107 used for the connection between the disk drives, when the plural disk drives 103 to 106 are connected to one another, the connection between the host system 100 and the disk drives connected to one another can be achieved by connecting the host system 100 and one of the disk drives (here, a disk drive 104) through the connector 108.

A mutual communication bus 102 is an interface through which the disk drives 103 to 106 mutually collaborate with one another to conduct the communication among the disk drives constituting the RAID system. As shown in FIG. 1, besides the mode in which the disk drives mutually connected by the connector 107, it is also possible that the mutual communication bus 102 has the mode in which the physical conducting wire is not used as a transmission medium, but the communication is conducted through power-conservation wireless communication.

(Configuration of Disk Drive)

FIG. 2 is the block diagram particularly showing the main part of the disk controller in each configuration of the disk drives 103 to 106. For the sake of convenience, the configuration of the disk drive (#1) 103 will typically be described.

The disk controller 20 includes a distributed RAID mode command processing block 200, a distributed RAID processing table (hereinafter referred to as distributed RAID table) 210, a single-mode command processing block 220, an inter-disk communication control block 230, a data restoring block 240, and a parity information generating block 250.

When the distributed RAID mode command processing block 200 receives a command from the host system 100 through the host interface bus 101, the distributed RAID mode command processing block 200 performs the RAID system constructing process. The single-mode command processing block 220 processes the host command for operating the disk drive in a usual single mode.

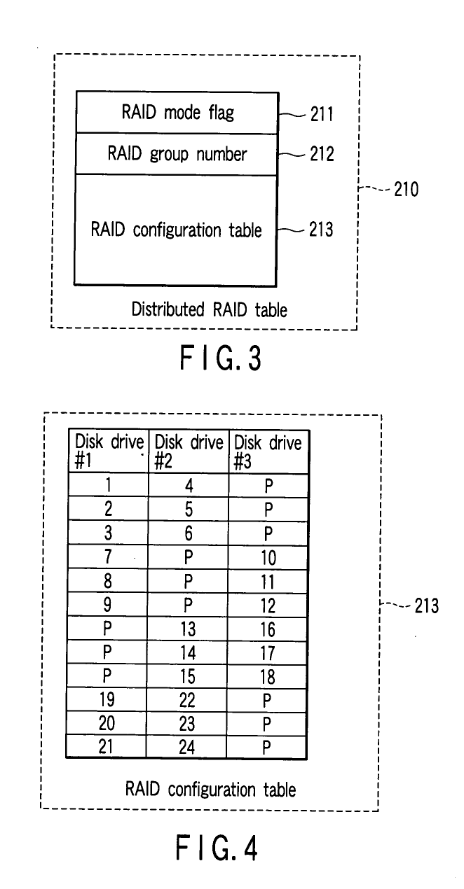

The distributed RAID mode command processing block 200 performs the RAID system constructing process using the distributed RAID processing table 210 having information shown in FIG. 3. The distributed RAID processing table 210 includes a RAID mode flag 211, a RAID group number 212, and a RAID configuration table 213.

The RAID mode flag 211 is set when a RAID system constructing command is received in the commands from the host system 100. When the RAID mode flag 211 of the distributed RAID table 210 is not set, the disk controller 20 transfer the control to the single-mode command processing block 220 so that the disk drive is operated as the single disk drive.

When the RAID mode flag 211 is set, the distributed RAID mode command processing block 200 exchanges control information and data with other disk drives through the inter-disk communication control block 230 based on the information of the RAID configuration table 213.

When the disk drive is operated as a parity drive from the information of the RAID configuration table 213, the distributed RAID mode command processing block 200 causes the parity information generating block 250 to generate parity information based on the data recorded in other disk drives, and the distributed RAID mode command processing block 200 records the parity information in the disk medium 10. In this case, when the other disk drive is broken down and the data is necessary to be restored by the parity information, the data restoring block 240 restores the recording data lost by the breakdown based on the data stored in other disk drives and the parity information.

As shown in FIG. 4, for example, when the RAID system is constructed by combining the disk drives 103 (#1) to 105 (#3), information for defining a block configuration on each desk drive is set in the RAID configuration table 213. In the information, P means the block in which the parity information is recorded.

(Constructing Operation of RAID System)

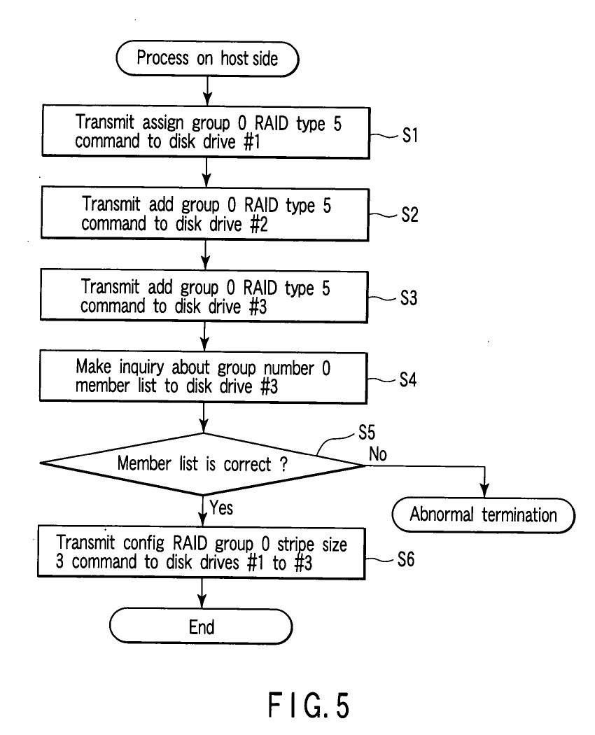

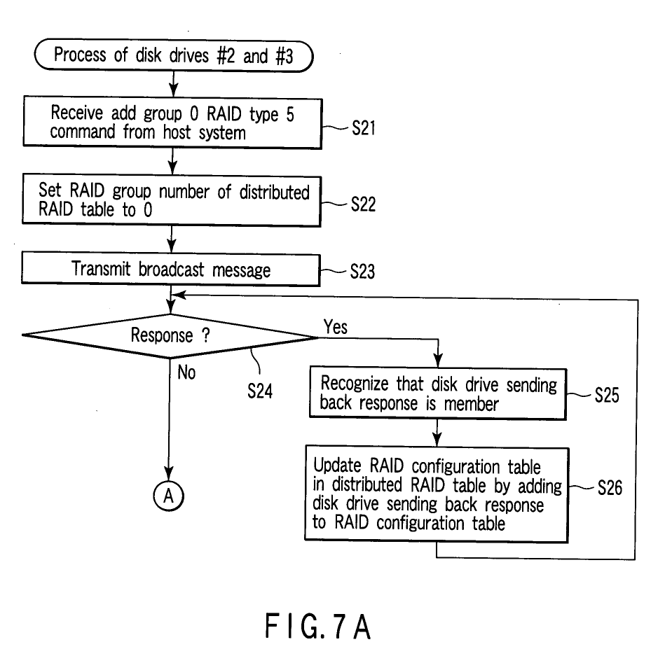

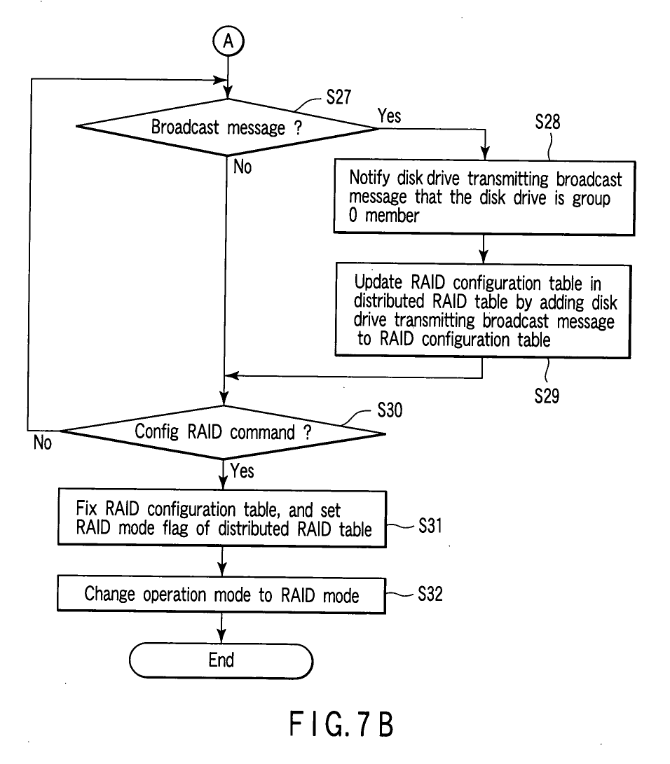

Referring to flowcharts shown in FIGS. 5 to 7B and FIGS. 8A to 8C and FIGS. 9A to 9C, the operation in the case where the RAID system of a RAID type 4 or a RAID type 5 is constructed will be described.

In this case, it is assumed that three disk drives (#1) to (#3) are connected to the host interface bus 101 and the disk drives (#1) to (#3) are also connected to the mutual communication bus 102. The disk drives (#1) to (#3) can exchange information with one another through the mutual communication bus 102.

As shown in FIG. 5, the host system 100 issues a RAID system constructing command (Assign Group 0 Raid type 5) to the disk drive #1 (Step S1). Then, the host system 100 issues the RAID system constructing commands (Add Group 0 Raid type 5) to the disk drives #2 and #3 (Steps S2 and S3).

The host system 100 makes an inquiry about a member list of a group number 0 to any one of the disk drives #1 to #3 or to all the disk drives #1 to #3, and the host system 100 confirms whether the RAID system constructing command is correctly recognized or not (Steps S4 and S5). When the RAID system constructing command is correctly recognized, for example, the host system 100 issues a command (Config RAID Group 0 Stripe Size 3) for performing change to the operation mode constructing the RAID system of a RAID type 5 in which one stripe is formed by three blocks in each of the disk drives #1 to #3 (YES in Step S5 and Step S6).

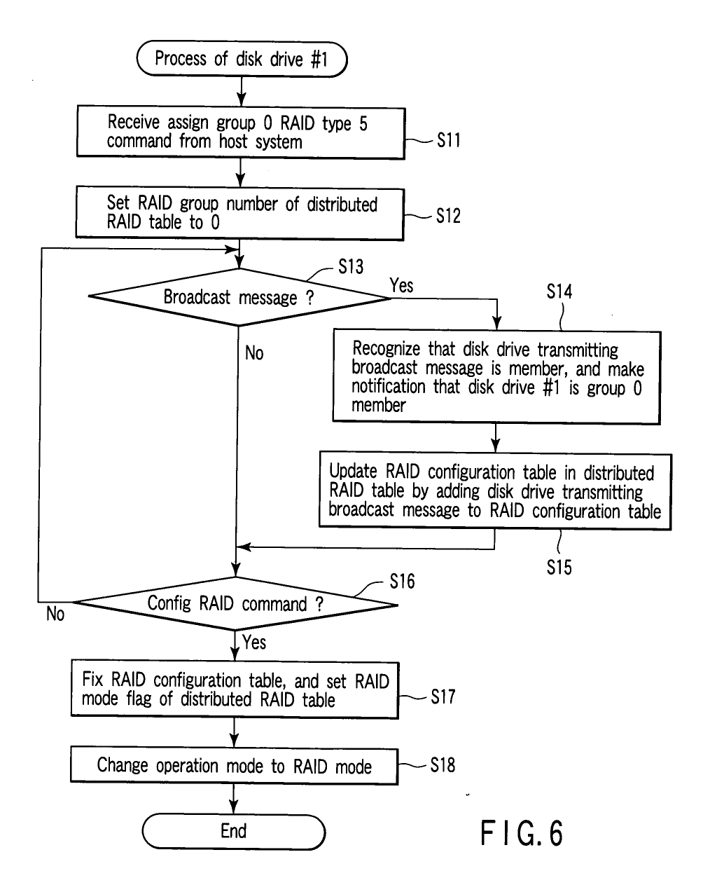

As shown in FIG. 6, the disk controller 20 of the disk drive #1 recognizes that the disk drives #1 is allocated as the initial disk drive of the RAID system having the group number 0 by the RAID type 5 received from the host system 100 (Step S11).

Specifically, as shown in FIG. 3, the distributed RAID mode command processing block 200 sets the number 0 as the RAID group number 212 in the distributed RAID table 210 (Step S12).

Then, the disk controller 20 of the disk drive #1 waits for the inquiry to be transmitted from other disk drives added to the RAID group number 0 through the mutual communication bus 102 (Step S13). When the disk controller 20 receives the inquiry from other disk drives added to the RAID group number 0, the disk controller 20 updates the RAID configuration table 213 in the distributed RAID table 210 by adding the disk drive which transmits the message to the RAID configuration table 213 (YES in Step S13, and Steps S14 and S15).

When the disk controller 20 of the disk drive #1 receives the command (Config RAID Group 0 Stripe Size 3) from the host system 100, the disk controller 20 fixes contents shown in FIG. 4 for the RAID configuration table 213 in the distributed RAID table 210 to set the RAID type number in the RAID mode flag 211 (Steps S17 and S18).

At this point, for example, the RAID type number is set to “−1” when the disk drive is stand-alone.

On the other hand, when each of the disk drives #2 and #3 receives the command from the host system 100, the disk drives #2 and #3 recognize that the disk drives #2 and #3 are added as the disk drive constituting the RAID system configuration of the RAID type 5 and the RAID system of the group number 0 (Step S21).

Specifically, as shown in FIG. 3, the distributed RAID mode command processing block 200 of each of the disk drives #2 and #3 sets the number 0 as the RAID group number 212 in the distributed RAID table 210 (Step S22).

The disk drives #2 and #3 send a broadcast message through the mutual communication bus 102 so that the disk drive which belongs to the group number 0 transmits the drive number (Step S23). When the disk drive #1 notifies the disk drives #2 and #3 that the disk drive #1 belongs to the group number 0 in response to the broadcast message, the disk drives #2 and #3 recognize that the disk drive #1 is the member, and the disk drives #2 and #3 update the RAID configuration table 213 in the distributed RAID table 210 by adding the disk drive #1 to the RAID configuration table 213 (Steps S25 and S26).

The disk drives #2 and #3 wait for the inquiry to be transmitted from the other disk drive added to the RAID group number 0 through the mutual communication bus 102 (Step S27). When the disk drives #2 and #3 receive the inquiry from other disk drives added to the RAID group number 0, the disk drives #2 and #3 update the RAID configuration table 213 in the distributed RAID table 210 by adding the disk drive which transmits the message to the RAID configuration table 213 (YES in Step S27, and Steps S28 and S29).

When the disk controller 20 of the disk drives #2 and #3 receives the command (Config RAID Group 0 Stripe Size 3) from the host system 100, the disk controller 20 fixes the contents shown in FIG. 4 for the RAID configuration table 213 in the distributed RAID table 210 to set the RAID type number in the RAID mode flag 211 (Steps S31 and S32).

Thus, the disk drives #1 to #3 recognize that each of the disk drives #1 to #3 is the member of the RAID group 0 by the mutual communication between the host system and the disk drives #1 to #3. The disk drives #1 to #3 set the RAID configuration table 213 and the RAID mode flag 211, and the disk drives #1 to #3 are operated as the disk drive constituting the distributed type RAID system.

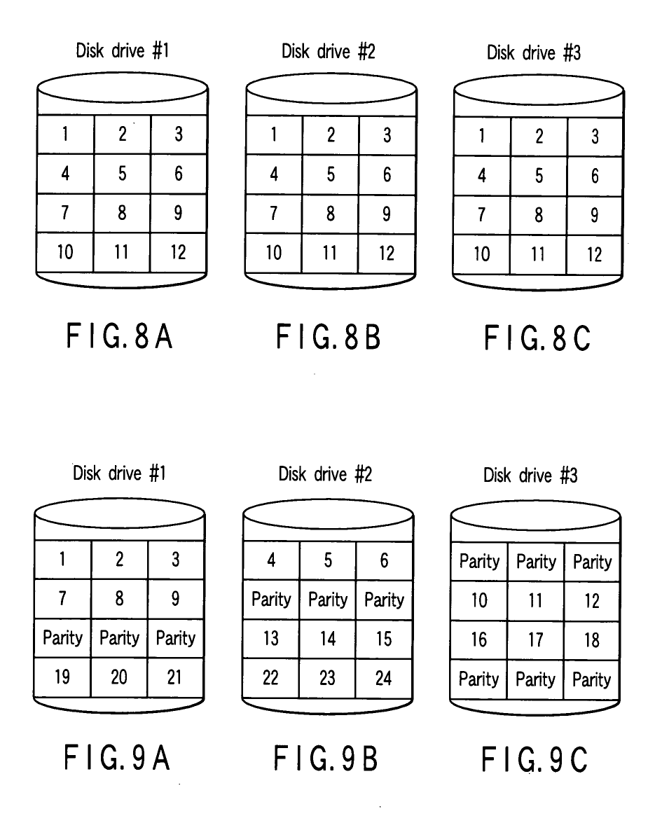

As shown in FIGS. 8A to 8C, in each of the disk drives #1 to #3, it is assumed that the total number of blocks is 12. Each of the disk drives #1 to #3 can recognize that the allocation of the logic addresses and parity blocks has the configuration shown in FIGS. 9A to 9C in the RAID system based of the number of disk drives in the group and the order of the disk drive number of each disk drive in the RAID configuration table 213.

When the RAID system is constructed, for example, the host system 100 gets access while the storage capacity of the disk drive #1 is increased. Assuming that the 24 blocks exists in the disk drive #1, the host system 100 gets access to the disk drive #1 as the single disk drive.

When the host system 100 gets access to the disk drive #1, each of the disk drives #1 to #3 determines whether the host system 100 gets access to itself or to another disk drive in the same group, or a data of other drive having the parity information, based on the logic address in the RAID configuration table 213.

(Specific Example of RAID Type 1)

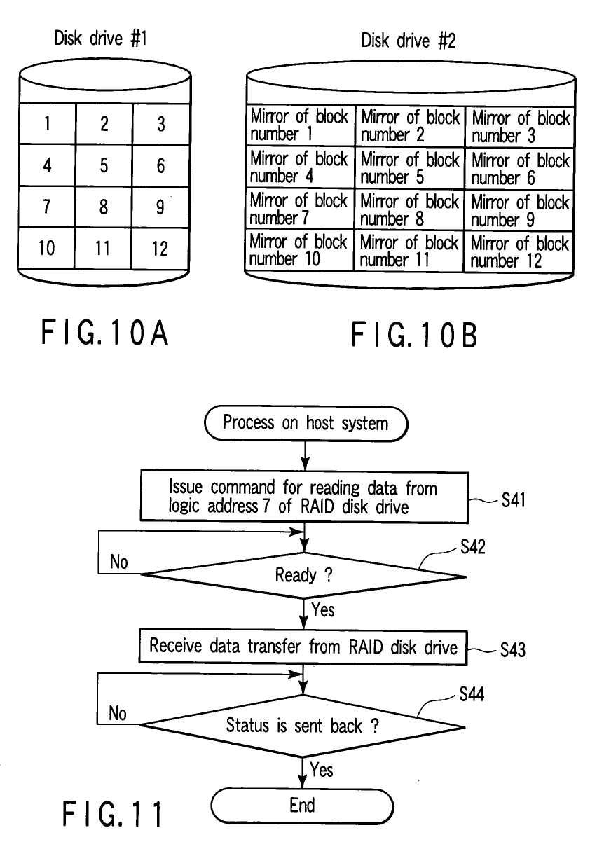

FIGS. 10A and 10B are a view showing a specific example when the method of constructing the RAID system of the first embodiment is applied to the construction of the RAID system of the RAID type 1.

In this case, it is assumed that the disk drives #1 and #2 are connected to the host interface bus 101. The disk drives #1 and #2 can be connected to the mutual communication bus 102 to exchange the information with each other.

The host system 100 issues the RAID system constructing command (Assign Group 0 Raid Type 1) to one disk drive, e.g. the disk drive #1. The disk drive #1 which receives the RAID system constructing command recognizes that the disk drive #1 is specified as the initial disk drive of the RAID system of the group number 0 in the RAID type 1. The disk drive #1 waits for the inquiry to be transmitted from the other drive disk which is added to the group number 0 through the mutual communication bus 102.

Then, the host system 100 issues the command (Add Group 0 Raid Type 1) to the disk drive #2. The disk drive #2 which receives the command recognizes that the disk drive #2 is added as the disk drive constituting the RAID system of the group number 0 in the RAID type 1.

The disk drive #2 sends the broadcast message through the mutual communication bus 102 so that the disk drive which belongs to the group number 0 transmits the drive number. When the disk drive #1 receives the broadcast message to notify the disk drive #2 that the disk drive #1 belongs to the group number 0, at this point, the disk drives #1 and #2 recognize that the disk drives #1 and #2 are the member in the group number 0 of the RAID type 1.

The host system 100 makes the inquiry about a member list of the group number 0 to one of the disk drives #1 and #2 or to both the disk drives #1 and #2, and the host system 100 confirms whether the RAID system constructing command is correctly recognized or not. When the RAID system constructing command is correctly recognized, for example, the host system 100 issues the command (Config RAID Group 0). The host system 100 directs to an operation mode such as the disk drives #1 and #2 to construct the RAID system of the RAID type 1.

Then, the host system can get the same access as the access to the single disk drive #1. In this case, the disk drive #2 recognizes that the logic address of the access to the drive #1 is the access to the same block address of the drive #2.

(First Specific Example of Data Read Control)

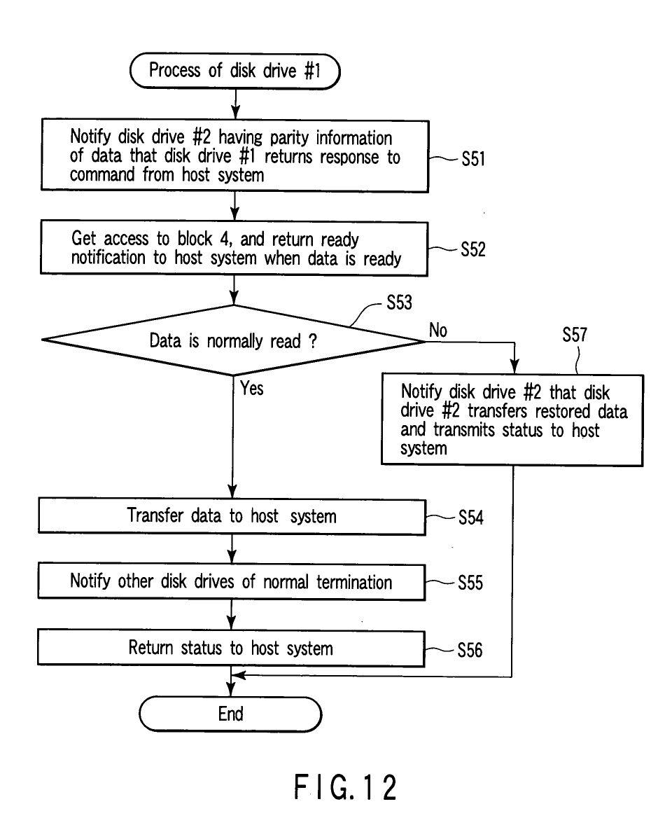

Then, data read control in the case where the RAID system of the RAID type 4 or RAID type 5 is constructed in the first embodiment will be described referring to the flowcharts shown in FIGS. 11 to 14.

When the RAID system is configured as shown in FIGS. 9A to 9C, the host system 100 issues a read command for reading the data from the logic address 7 (Step S41). The disk drive #1 which receives the read command through the host interface bus 101 can recognize that the read command for reading the data from the logic address 7 is the access to the block 4 of the disk drive #1 itself, so that the disk drive #1 returns a ready notification to the host system at the time when the data is ready (YES in Step S42 and Step S52).

The disk drive #1 notifies the disk drive #2 having the parity information of the data that the disk drive #1 responds to the host system through the mutual communication bus 102 at the time when the disk drive #1 recognizes that the read command for reading the data from the logic address 7 is the access to the block 4 of the disk drive #1 itself (Step S51).

The disk drive #1 transmits the normally read data in response to a request from the host system, and the disk drive #1 returns status information to the host system (YES in Step S53, and Steps S54 and S56). At this point, the disk drive #1 notifies the disk drive #2 of normal termination (Step S55). Therefore, the host system 100 receives the read data from the disk drive #1, and the data readout is ended at the time when the status information is returned (Step S43 and YES in Step S44).

When the data of address 4 corresponding to the logic address 7 is broken down and the data cannot normally be read, the disk drive #1 notifies the disk drive #2 having the parity information that the disk drive #2 transfers the restored data and the status information to the host system 100 (NO in Step S53 and Step S57).

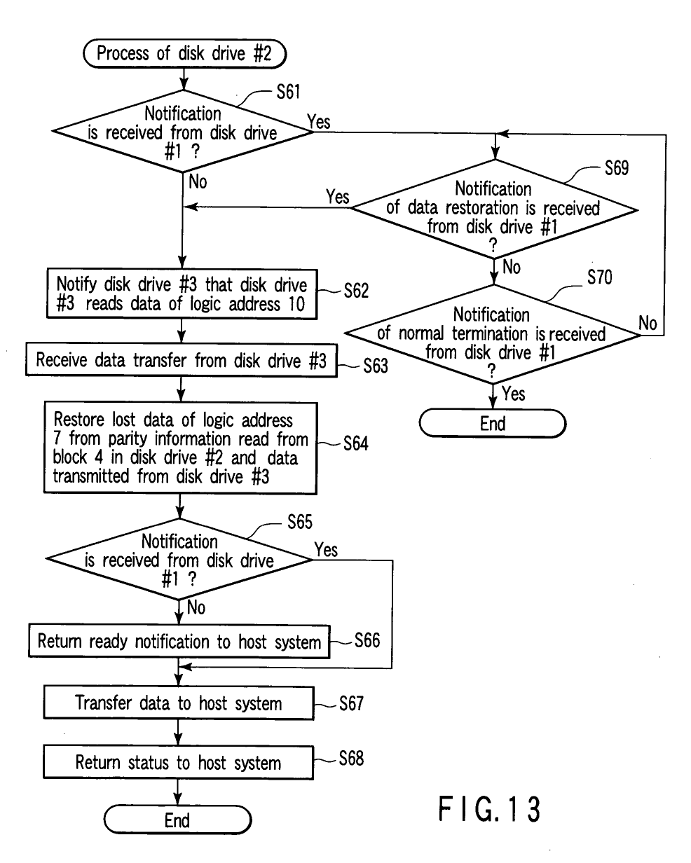

When the disk drive #1 is broken down, as shown in FIG. 13, since the disk drive #2 having the parity information does not receive the notification from though the mutual communication bus 102, in order to restore the original data using the parity information of the disk drive #2, the disk drive #2 notifies the disk drive #3 that the disk drive #3 reads the data in the logic address 10 which shares the same parity with the logic address 7 (NO in Step S61 and Step S62).

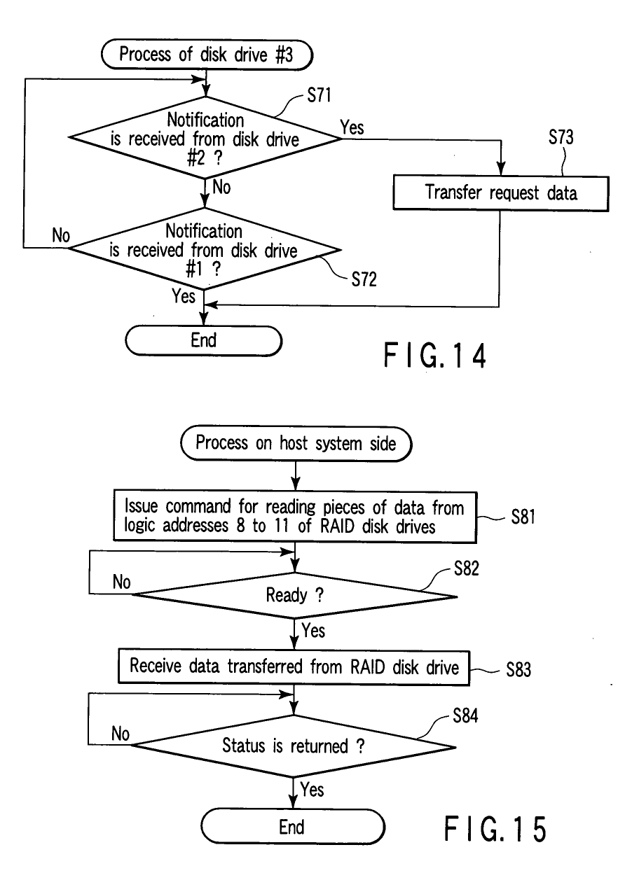

As shown in FIG. 14, the disk drive #3 reads the data in the block 4 of the disk drive #3 corresponding to the logic address 10, and the disk drive #3 transfers the data to the disk drive #2 through the mutual communication bus 102 (YES in Step S71 and Step S73).

As shown in FIG. 13, the disk drive #2 restores the lost data of the logic address 7 from the parity information and the data transferred from the disk drive #3 (Steps S63 and S64). The disk drive #2 returns the ready notification to the host system 100, and the disk drive #2 transfers the data in response to the request from the host system 100. Finally the disk drive #2 returns the status information to the host system 100 (Steps S65 to S68).

(Second Specific Example of Data Read Control)

The data read control in the RAID system of the RAID type 4 or RAID type 5 of the first embodiment in the case where the access data extends over the plural disk drives will be described referring to the flowcharts shown in FIGS. 15, 16, 17A, 17B, and 18.

As shown in FIG. 15, the read request of the host system 100 extends from the logic address 8 to the logic address 11 (Step S81). In this case, for example, the disk drive #1 responds to the command from the host system and the disk drive #1 also performs the response of the status after the command is performed (Steps S82 to S84).

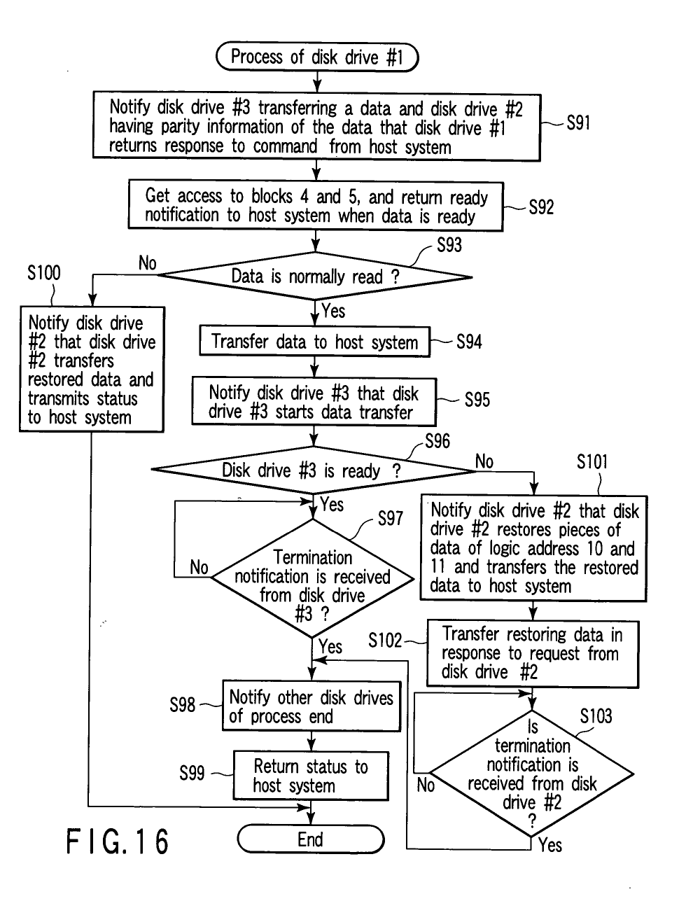

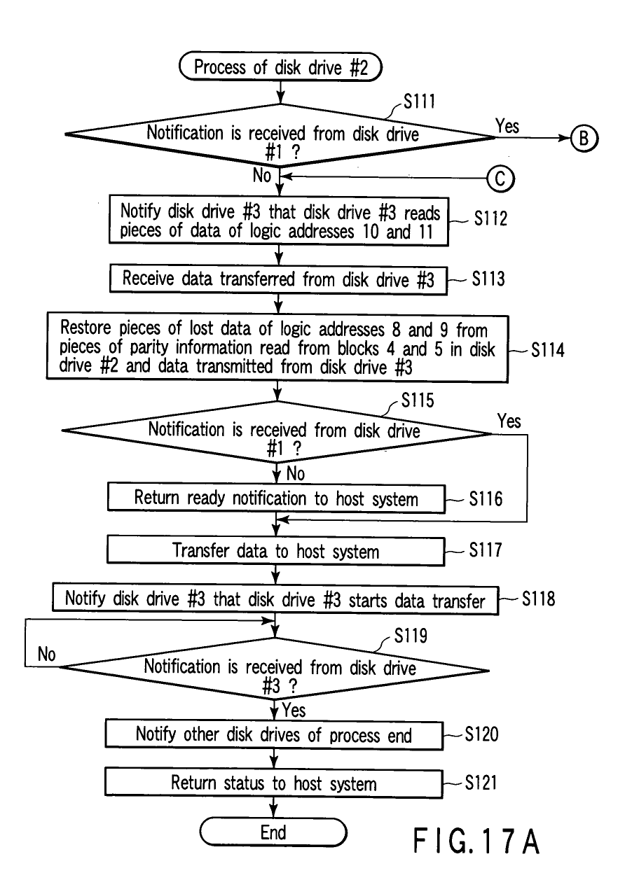

As shown in FIG. 16, the disk drive #1 notifies the disk drive #3 and the disk drive #2 having the parity information of the data that the disk drive #1 responds to the command from the host system 100 through the mutual communication bus 102 (Step S91).

The disk drive #1 returns the ready notification to the host system 100 at the time when the data stored in the disk drive #1 is ready (Step S92). Then, the disk drive #1 transfers the pieces of data in the logic addresses 8 and 9 in response to the request of the host system 100 (Step S94). The disk drive #1 notifies the disk drive #3 through the mutual communication bus 102 that the disk drive #3 starts to transfer the data (Step S95).

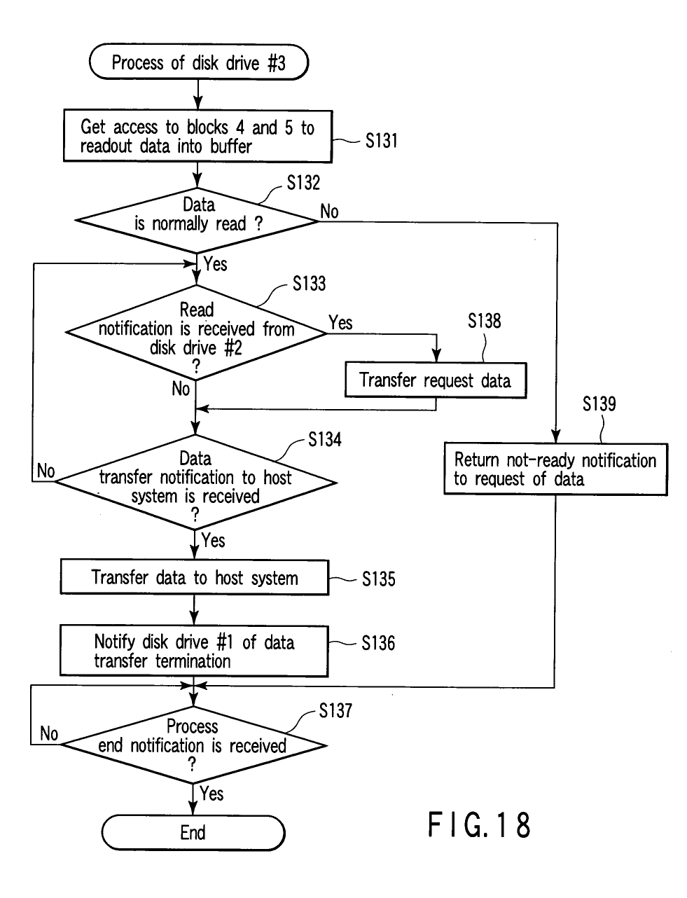

As shown in FIG. 18, when the data transfer is terminated, the disk drive #3 notifies the disk drive #1 of the status and the termination of the data transfer through the mutual communication bus 102 (Steps S135 and S136).

When the disk drive #1 receives the transfer termination notification from the disk drive #3, the disk drive #3 returns execution result status of the command to the host system 100 while the disk drive #1 notifies the disk drive #2 of the transfer termination (YES in Step S97 and Steps S98 and S99).

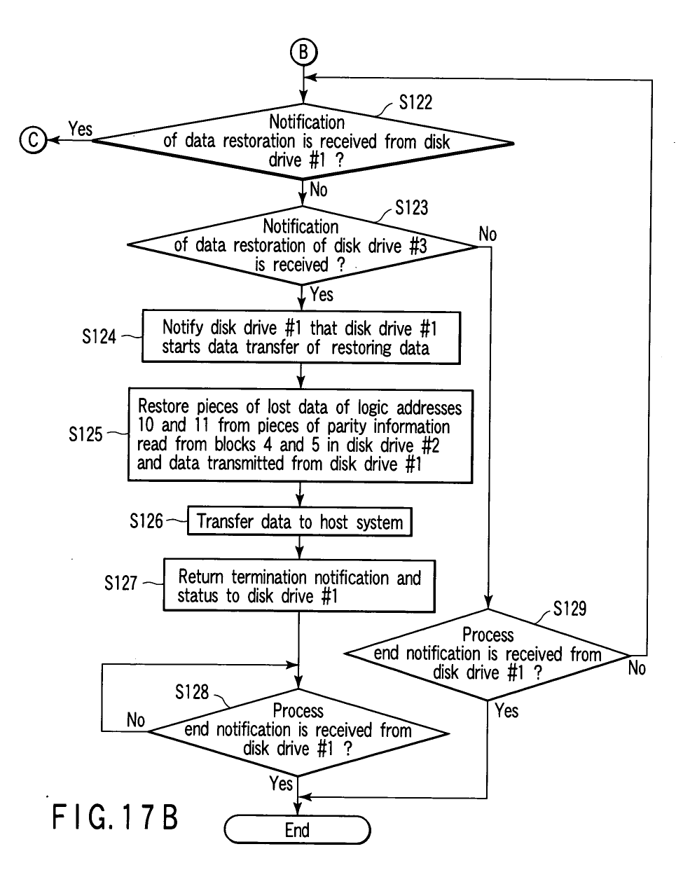

At this point, as shown in FIG. 17A, when the disk drive #2 does not receive the notification through the mutual communication bus 102, the disk drive #2 having the parity information determines that the disk drive #1 is broken down, and the disk drive #2 performs the process of restoring the original data using the parity information (NO in Step S111). The disk drive #2 notifies the disk drive #3 that the disk drive #3 reads the data addresses 11 and 12 which share the parity with the logic addresses 8 and 9 (Step S112).

As shown in FIG. 18, the disk drive #3 reads the data which the disk drive #2 requests to transfer the data to the disk drive #2 through the mutual communication bus 102 (YES in Step S133 and Step S138).

As shown in FIG. 17A, the disk drive #2 restores the lost data from the parity information and the data transferred from the disk drive #3 (Steps S113 and S114). In this case, the data to be transferred exists on the buffer of disk drive, so that the disk drive #2 returns the ready notification to the host system 100 (NO in Step S115 and Step S116).

The disk drive #2 transfers the data in response to the request from the host system 100 (Step S117). The disk drive #2 notifies the disk drive #3 that the disk drive #3 starts to transfer the data through the mutual communication bus 102 (Step S118).

As shown in FIG. 18, after the data transfer, the disk drive #3 notifies the disk drive #2 of the status and the termination of the data transfer through the mutual communication bus 102 (YES in Step 134 and Steps S135 and S136).

When the disk drive #2 receives the transfer termination notification from the disk drive #3, the disk drive #2 returns the execution result status of the command to the host system 100 (YES in Step S119 and Step S121).

In the case that drive #3 has trouble on the other hand, as shown in FIG. 16, the disk drive #1 cannot confirm that the pieces of data of the logic addresses 10 and 11 are ready in the disk drive #3, so that the disk drive #1 determines that the disk drive #3 is broken down (NO in Step S96).

The disk drive #1 notifies the disk drive #2 having the parity information that the disk drive #2 restores the data and transfers the data to the host system 100 on behalf of the disk drive #3 (Step S101).

As shown in FIG. 17B, in order to restore the pieces of data of the logic addresses 10 and 11, the disk drive #2 requests the disk drive #1 to transfer the pieces of data of the logic addresses 8 and 9 through the mutual communication bus 102 (YES in Step S123 and Step S124).

Accordingly, the disk drive #1 transfers the pieces of data of the logic addresses 8 and 9 to the disk drive #2 through the mutual communication bus 102 (Step S102). Alternatively, the disk drive #2 recognizes that the disk drive #1 transmits the necessary data onto the host interface bus 101, so that the disk drive #2 does not transmit the data transfer request, but the disk drive #2 may monitor the data which is transferred from the disk drive #1 to the host system 100.

After the disk drive #2 transfers the restored data to the host system 100, the disk drive #2 notifies the disk drive #1 of the status and the termination of the data transfer (Steps S126 and S127). When the disk drive #1 receives the notification from the disk drive #2, the disk drive #2 returns the status to the host system 100 (YES in Step S103 and Step S99).

(Third Specific Example of Data Read Control)

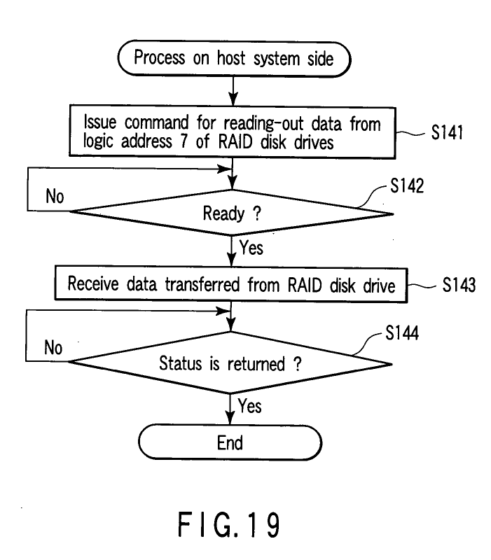

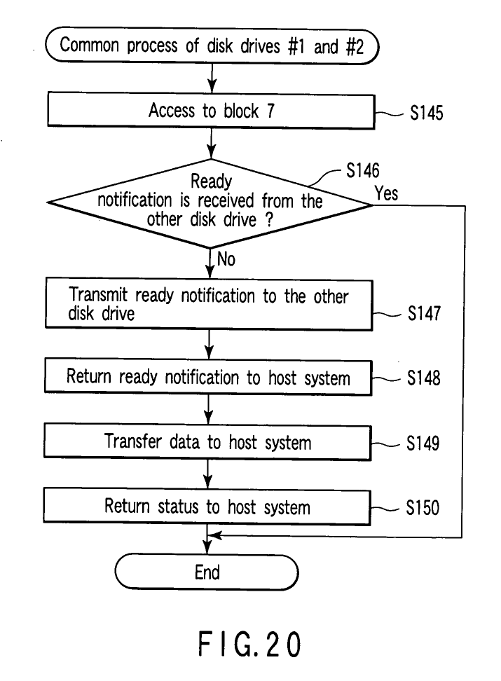

The data read control in the RAID system of the RAID type 1 of the first embodiment will be described referring to the flowcharts shown in FIGS. 19 and 20.

In the RAID system configuration shown in FIGS. 10A and 10B, the host system 100 issues the read command for reading the data from the logic address 7 as shown in FIG. 19 (Step S141). When the host system 100 receives the request data and the status from the disk drive #1 or #2, the host system 100 ends the read operation (Step S143 and YES in Step S144).

As shown in FIG. 20, the disk drives #1 and #2 get access to the data of the block address 7 in response to the read command (Step S145). One of the disk drives #1 and #2 which antecedently succeeds to get access to the data transmits the ready notification to the other disk drive through the mutual communication bus 102 and also return the ready notification to the host system (Steps S146 to S148).

Assuming that the disk drive #1 transmits the ready notification, the disk drive #1 seizes the initiative of all the following read operation. Namely, the disk drive #1 reads all the pieces of data which the host system 100 requests from the disk of the disk drive #1 to transfer all the pieces of data (Step S149). Alternatively, the disk drive #1 predicts the address in which the data readout is delayed by seek operation, and the disk drive #2 prefetches the data from the same address to transfer the data to the host system 100. The disk drive #1 returns the status to the host system 100 at the time when the data transfer is terminated (Step S150).

In the RAID type 1, when one of the disk drives #1 and #2 is broken down, the ready notification is not transmitted, and the response to the data transfer substitution request is not also returned. Therefore, only the other disk drive is operated as the single disk drive.

(First Specific Example of Data Write Control)

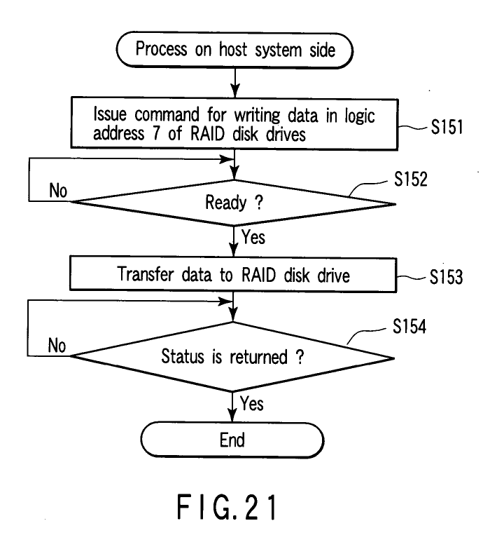

Then, data write control in the RAID system of the RAID type 4 or RAID type 5 of the first embodiment will be described referring to FIGS. 21 to 24.

In the RAID system configuration shown in FIGS. 9A to 9C, the host system 100 issues a write command for writing the data in the logic address 7 as shown in FIG. 21 (Step S151). When the host system 100 transfers the write data to the disk drive #1 and receives the status from the disk drive #1, the host system 100 terminates the write operation (Step S153 and YES in Step S154).

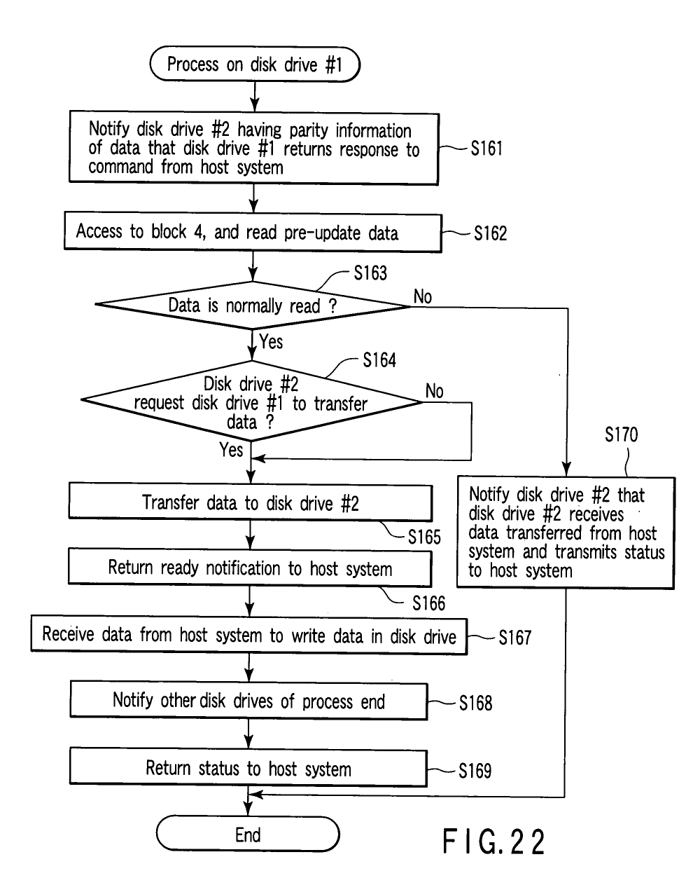

When the disk drive #1 receives the write command upon the host interface bus 101, the disk drive #1 recognizes that the write command for writing the data in the logic address 7 is the access to the block 4 of the disk drive #1 itself. At this point, as shown in FIG. 22, the disk drive #1 notifies the disk drive #2 having the parity information of the data that the disk drive #1 responds to the command from the host system 100 through the mutual communication bus 102 (Step S161).

The disk drive #2 recognizes that the parity information to the logic address 7 exists in the block 4 of the disk drive #2 itself. The disk drive #2 also recognizes that the data of the logic address 10 (=block 4 of the disk drive #3) concerning the parity creation is not updated. Therefore, the disk drive #2 reads the data of the block 4 into the buffer in order to update the parity for the written data.

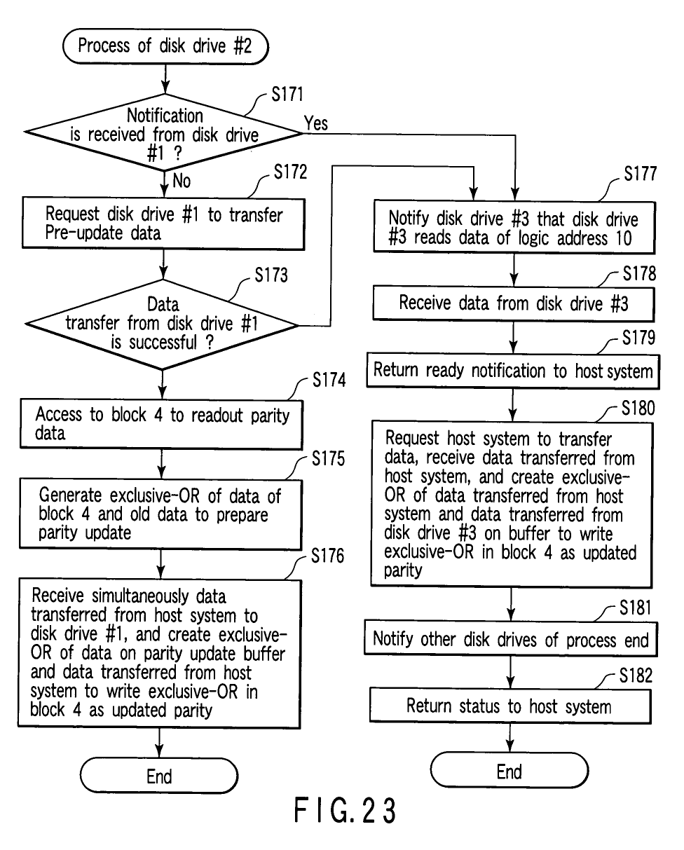

As shown in FIG. 23, the disk drive #2 request the disk drive #1 to transfer the old data of the logic address 7 which is the update object to the disk drive #2 through the mutual communication bus 102 (YES in Step S171 and Step S172). The disk drive #2 creates exclusive-OR of the data of the block 4 and the old data to prepare to the parity update (Steps S174 and S175).

On the other hand, as shown in FIG. 22, after the disk drive #1 transfers the old data of the logic address 7 to the disk drive #2, the disk drive #1 confirms whether the disk drive #2 transmits the ready notification or not through the mutual communication bus 102 (YES in Step S164 and Step S165). When the disk drive #1 receives the ready notification from the drive #2 the disk drive #1 immediately returns the ready notification to the host system 100 (Step S166).

However, even in the case where the response is not transmitted because the disk drive #2 is broken down, the disk drive #1 returns the ready notification when the disk drive #1 is ready for writing, and the disk drive #1 continues the performance of the command. The disk drive #1 receives the data transfer from the host system 100 to write the data in the disk (Step S167).

As shown in FIG. 23, the disk drive #2 simultaneously receives the data which is transferred from the host system 100 to the disk drive #1, and the disk drive #2 creates exclusive-OR of the data transferred from the host system 100 and the data on the parity update buffer and updates the parity in the block 4 (Step S176).

The disk drive #1 confirms the status of write operation to the block 4 of the disk drive #1 and the status of write operation of the parity of the disk drive #2 through the mutual communication bus 102. When one of the status of write operation to the block 4 and the status of write operation of the parity is successful, the disk drive #1 returns status information of the completion to the host system 100 (Step S169). When both the status of write operation to the block 4 and the status of write operation of the parity are not successful, the disk drive #1 returns the status of an error to the host system 100.

As shown in FIG. 23, when the notification is not transmitted through the mutual communication bus 102, the disk drive #2 having the parity information determines that the disk drive #1 is broken down (NO in Step S171). In this case, the disk drive #2 recognizes that the disk drive #2 should respond to the host system 100. Further, since the disk drive #2 cannot receive to be updated data from the disk drive #1, the disk drive #2 requests the disk drive #3 to read the data of the logic address 10 necessary for the parity creation through the mutual communication bus 102 (Step S177).

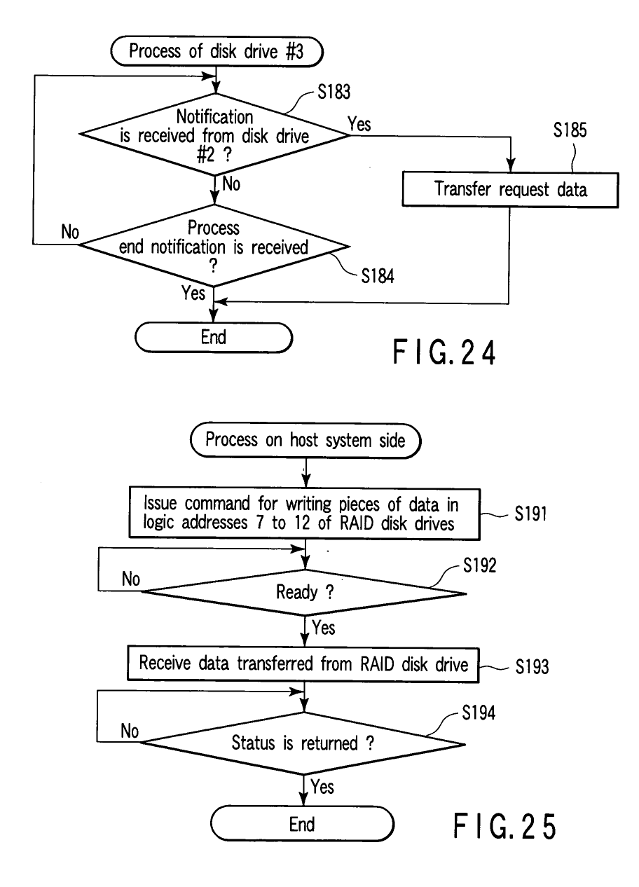

As shown FIG. 24, the disk drive #3 transfers the data which the disk drive #2 requests the disk drive #3 to transfer. When the disk drive #3 receives the process termination notification, the disk drive #3 ends the process (Steps S183 to S185).

When the disk drive #2 receives the data from the disk drive #3, the disk drive #2 returns the ready notification to the host system 100 (Steps S178 and S179). The disk drive #2 receives the data which the disk drive #2 requests the host system 100 to transfer. The disk drive #2 creates the exclusive-OR of the data transferred from the host system 100 and the data of the logic address 10 on the buffer, which is transferred from the disk drive #3, and updates the parity in the block 4 (Step S180). Finally, while the disk drive #2 notifies other disk drives of the process termination, the disk drive #2 returns the status to the host system 100 (Steps S181 and S182).

(Second Specific Example of Data Write Control)

The data write control in the RAID system of the RAID type 4 or RAID type 5 of the first embodiment in the case where the access data extends over the plural disk drives will be described referring to the flowcharts shown in FIGS. 25, 26, 27A, 27B, and 28.

In the RAID system configuration shown in FIGS. 9A to 9C, the host system 100 issues the write command for writing the data in the logic addresses 7 to 12 as shown in FIG. 25 (Step S191). The host system 100 transfers the write data to, e.g. the disk drive #1. When the host system 100 receives the status, the host system 100 ends the write operation (Step S193 and YES in Step S194).

In this case, for example the disk drive #1 responds to the command from the host system, and the disk drive #1 also performs the response of the status after the command is performed.

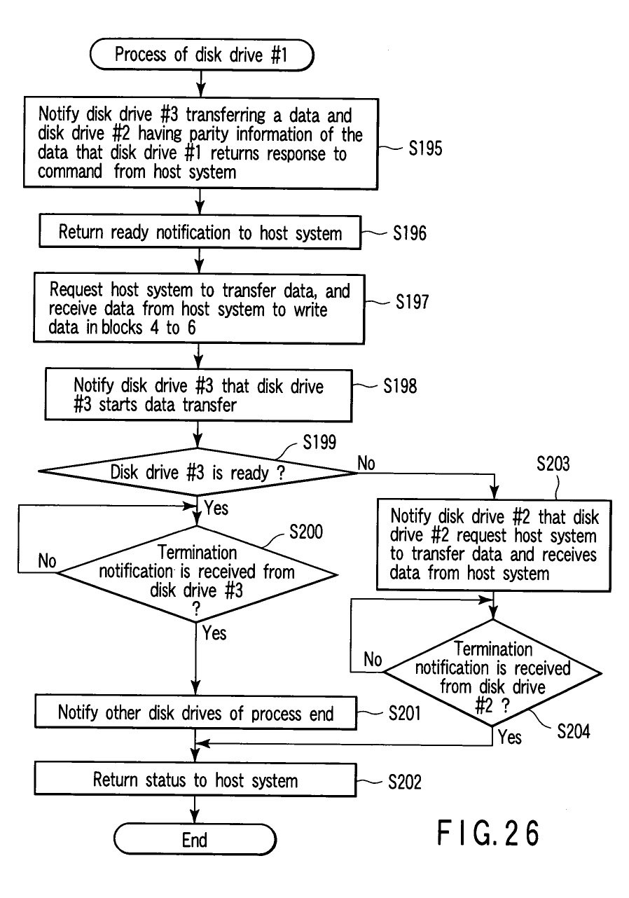

As shown in FIG. 26, the disk drive #1 notifies the disk drive #3 and the disk drive #2 having the parity information of the data that the disk drive #1 responds to the command from the host system 100 through the mutual communication bus 102 (Step S195).

The disk drive #2 recognizes that the pieces of parity information to the logic addresses 7 to 12 exist in the blocks 4 to 6 of the disk drive #2 itself. The disk drive #2 also recognizes that that all the pieces of data concerning the parity creation are updated. Therefore, the disk drive #2 recognizes that it is not necessary to read the old parity information in order to update the parity information.

The disk drive #1 confirms whether the disk drives #2 and #3 transmit the ready notifications or not through the mutual communication bus 102. When the disk drive #1 confirms the ready notifications of the disk drives #2 and #3, the disk drive #1 immediately returns the ready notification to the host system 100 (Step S196). However, even in the case where one of the disk drives #2 and #3 is broken down and there are no response, the disk drive #1 returns the ready notification to the host system 100 when the disk drive #1 is ready for writing, and the disk drive #1 continues the performance of the command. The disk drive #1 requests the host system 100 to receive the data transferred from the host system 100.

When both the disk drives #2 and #3 are broken down, because the data cannot be written in the logic addresses 10 to 12, the disk drive #1 returns the error status.

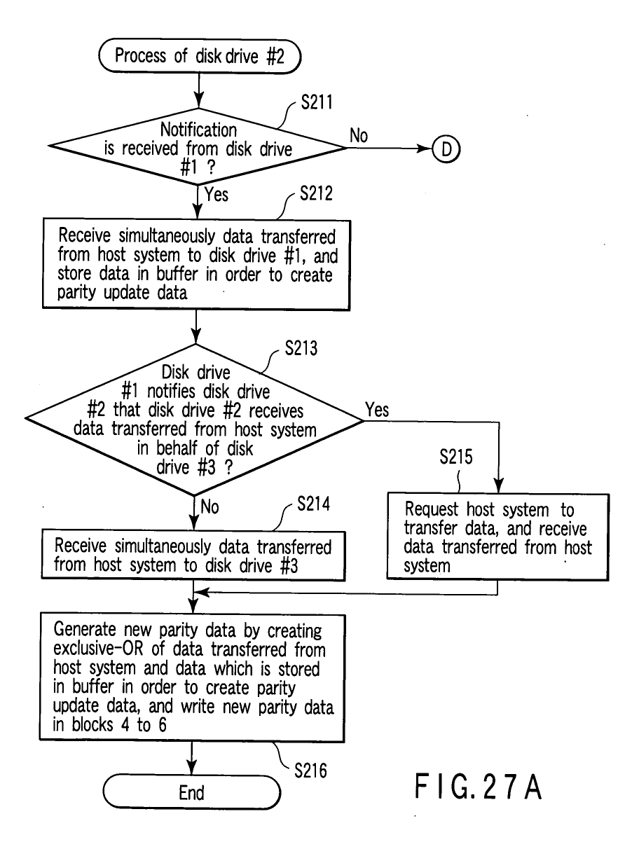

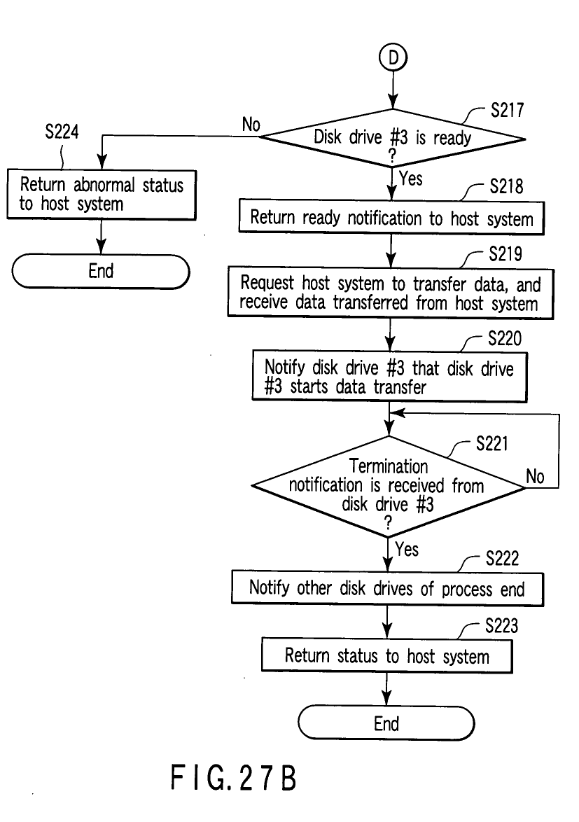

As shown in FIG. 27A, the disk drive #2 simultaneously receives the data which is transferred from the host system 100 to the disk drive #1, and the disk drive #2 stores the data in the buffer in order to update the parity. However, the disk drive #2 does not write the data yet (Step S212).

The disk drive #1 requests the host system 100 to transfer the data. When the disk drive #1 receives the data transferred from the host system 100, the disk drive #1 writes the data in the blocks 4 to 6, and the disk drive #1 notifies the disk drive #3 that the disk drive #3 starts the data transfer through the mutual communication bus 102 (Steps S197 and S198). When the disk drive #1 receives the transfer termination notification from the disk drive #3, the disk drive #1 returns the execution result status of the command to the host system 100 (YES in Step S200 and Step S202).

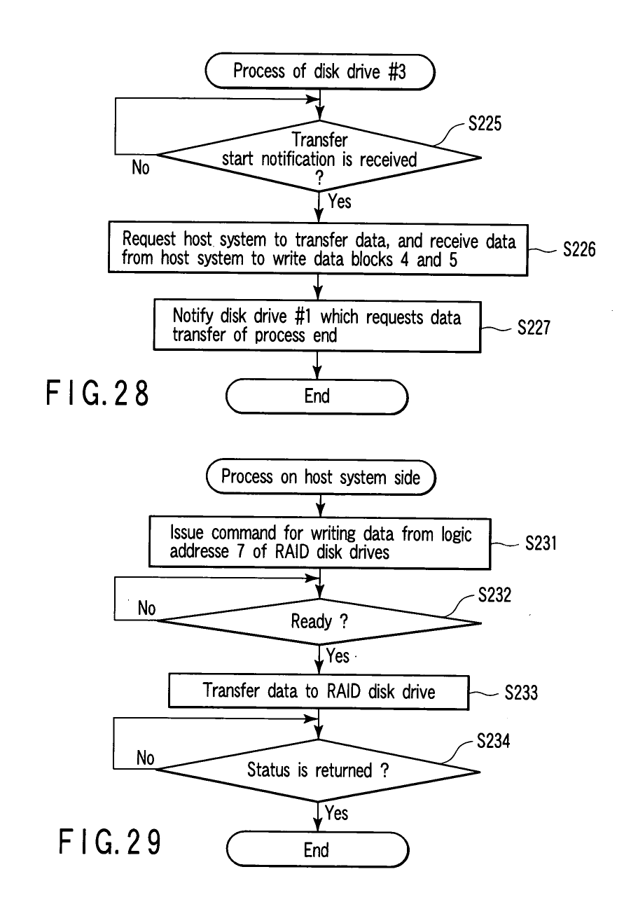

As shown in FIG. 28, when the data transfer is terminated, the disk drive #3 notifies the disk drive #1 of the status and the data transfer termination through the mutual communication bus 102 (Steps S225 to S227).

As shown in FIG. 27A, the disk drive #2 simultaneously receives the data which is transferred from the host system 100 to the disk drive #3. The disk drive #2 creates the new parity and writes the new parity data in the blocks 4 to 6. The new parity is made of the exclusive-OR of the data transferred from the host system 100 and the data which is stored in the buffer (Steps S214 and S216).

At this point, if the notification from drive #1 is not transmitted through the mutual communication bus 102 the disk drive #2 having the parity information determines that the disk drive #1 is broken down (NO in Step S211). In this case, as shown in FIG. 27B, the disk drive #2 confirms the ready notification of the disk drive #3 through the mutual communication bus 102, and the disk drive #2 returns the ready notification to the host system 100 (YES in Step S217 and Step S218).

Further, the disk drive #2 request the host system to transfer the data, and the disk drive #2 receives the data transferred from the host system. Then, the disk drive #2 notifies the disk drive #3 that the disk drive #3 starts the data transfer through the mutual communication bus 102 (Steps S219 and S220).

When the data transfer is terminated, the disk drive #3 notifies the disk drive #2 of the status and the data transfer termination through the mutual communication bus 102. Finally, the disk drive #2 returns the execution result status of the command to the host system 100 (Step S223).

If the disk drive #2 is broken down, although the parity information is not written, the process is proceeds like the normal operation. If the disk drive #3 is broken down, while the data is transferred to the drive #1, like the normal operation, the disk drive #2 simultaneously receives the data transferred from the host system 100 to the disk drive #1, and the disk drive #2 stores the data in the buffer in order to update the parity. However, the disk drive #2 does not write the data yet.

The disk drive #1 requests the host system 100 to transfer the data. After the disk drive #1 receives the data transferred from the host system 100, the disk drive #1 notifies the disk drive #2 that the disk drive #2 starts to receive the data from the host through the mutual communication bus 102 (Step S203).

The disk drive #2 requests the host system 100 to transfer the data, and the disk drive #2 receives the data transferred from the host system 100. Then, the disk drive #2 updates the parity and writes the parity to the blocks 4 to 6. The new parity is made of exclusive-OR of the data transferred from the host system 100 and the data which is stored in the buffer in order to create the parity update data (Step S216). When the data transfer is terminated, the disk drive #2 notifies the disk drive #1 of the status and the data transfer termination through the mutual communication bus 102. Finally, the disk drive #1 returns the execution result status of the command to the host system 100 (Step S202).

(Third Specific Example of Data Write Control)

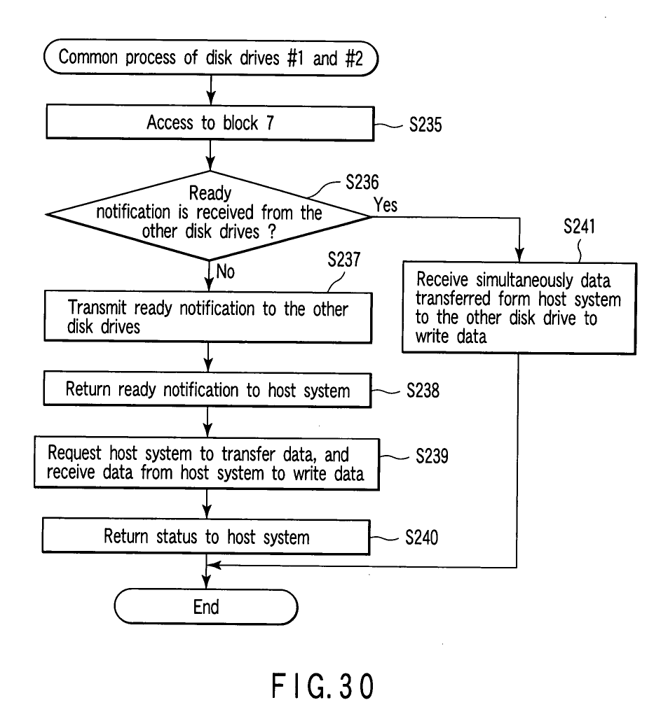

The data write control in the RAID system of the RAID type 1 of the first embodiment will be described referring to the flowcharts shown in FIGS. 29 and 30.

In the RAID system configuration shown in FIGS. 10A and 10B, the host system 100 issues the write command for writing the data to the logic address 7 as shown in FIG. 29 (Step S231). The host system 100 transfers the data to the disk drive #1 or #2. When the host system 100 receives the status from the disk drive #1 or #2, the host system 100 terminates the write operation (Step S233 and YES in Step S234).

As shown in FIG. 30, the disk drives #1 and #2 get access to the data of the block address 7 in response to the write command (Step S235). The disk drives #1 and #2 seek individually to the data position of the block address 7. One of the disk drives #1 and #2 which antecedently succeeds to seek to the data position of the block address 7 transmits the ready notification to the other disk drive through the mutual communication bus 102 and also return the ready notification to the host system (Steps S236 to S238).

Assuming that the disk drive #1 transmits the ready notification, the disk drive #1 seizes the initiative of all the following write operation. Namely, the disk drive #1 requests the host system 100 to transfer the data, and the disk drive #1 receives the data transferred from the host system 100. When the data transfer is terminated, the disk drive #1 also performs status response to the host system 100 (Steps S239 and S240). However, the disk drive #2 monitors the data transferred to the disk drive #1 to write the data in the same block as the disk drive #2 itself.

In the RAID type 1, when one of the disk drives #1 and #2 is broken down, since the ready notification is not transmitted from the troubled drive, only the other disk drive is operated as the single disk drive.

In the case of the data write operation, since the process can be advanced by storing the data in the buffer even before the seek to the required block position, in this case, the disk drive #1 is configured to always provide the ready notification. When the disk drive #1 does not provide the ready notification due to the breakdown of the disk drive #1, the disk drive #2 is operated as the stand-alone drive.

The mutual communication bus 102 is one which is shared with the plural disk drives. For example, like the SCSI interface, the mutual communication bus 102 includes 8 to 32 data bus lines and control signal lines such as RST, ATN, ACK, REQ, MSG, I/O, C/D, SEL, and BSY. For example, the mutual communication bus 102 has an arbitration function and a broadcast message protocol, and on the basis of such as the serial number of the drive, the disk drives connected to BUS can assign the drive number to one another.

When the host interface bus 101 is pursuant to ATA, the number of disk drives recognized on the host interface bus 101 is limited to two disk drives. When at least the three disk drives are connected to the host interface bus 101, one of the disk drives is set to a primary disk drive and other disk drives are set to a secondary disk drive.

The command for constructing RAID is issued to the primary disk drive from the host system 100. The drive number to which the RAID constructing command should actually be executed is specified as a command parameter. When the primary disk drive which receives the RAID constructing command recognizes from the command parameter that the RAID constructing command should be executed by other disk drives, the primary disk drive transfers the RAID constructing command to the specified through the mutual communication bus 102.

The specified disk drive which receives the RAID constructing command through the mutual communication bus 102, the specified disk drive returns the status to the primary disk drive through the mutual communication bus 102. The primary disk drive which receives the status from the specified disk drive transfers the status to the host system through the host interface bus 101.

### Second Embodiment

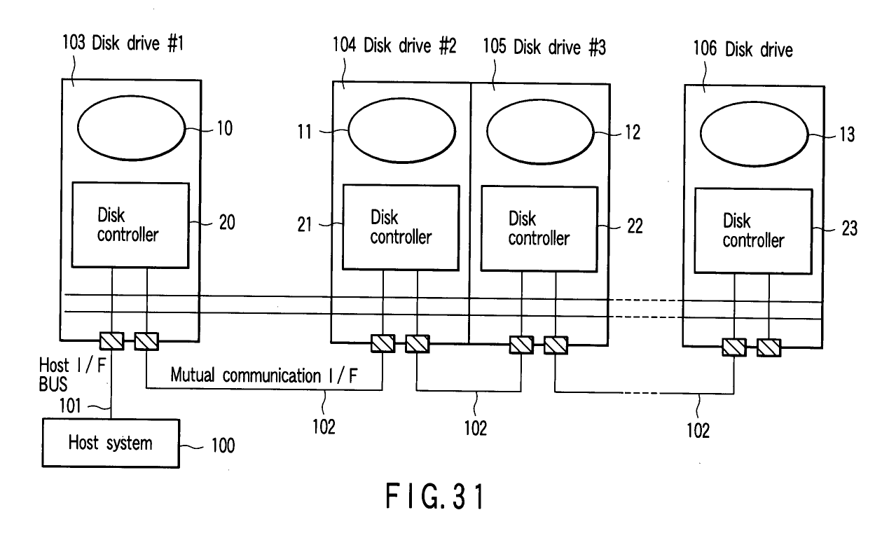

FIG. 31 is a block diagram showing the configuration of the RAID system according to a second embodiment.

In the second embodiment, only one disk drive (#1) 103 is connected to the host system 100, and the RAID system is formed by connecting the connector which is not connected to the host system 100 to another disk drive.

It is assumed that the communication between the host system 100 and the disk drive 103 and the communication between disk drives are conducted through the serial interfaces 101 and 102. The serial interfaces 101 and 102 includes signal lines such as transmission TX+, transmission TX−, reception RX+, and reception RX−.

The serial interface transmits and receives the command, the status, and the data by using hierarchical structures such as a physical layer, a link layer, and transport layer. In the physical layer, types and levels of the signal lines are defined. In the link layer, an information frame is transmitted and received. In the transport layer, the information frame is constructed for the transmission and the received information frame is disassembled.

The communication with the host system 100 is performed by the disk controller 20 of the disk drive (#1) 103. The disk controller 20 receives the command issued from the host system 100 to determine the contents of the subsequent process.

The controller 20 of disk drive #1 and the controller 21 of the disk drive #2 are connected to each other with the same cable as the cable which connects the host system 100 and the controller 20 of the disk drive #1. The controller 20 and the controller 21 are connected by the same communication mode up to the physical layer and the link layer.

The plural disk drives can be connected in series by the above connection configuration. Theoretically, as shown in FIG. 31, n disk drives are connected to one another in series to form the RAID system.

### Third Embodiment

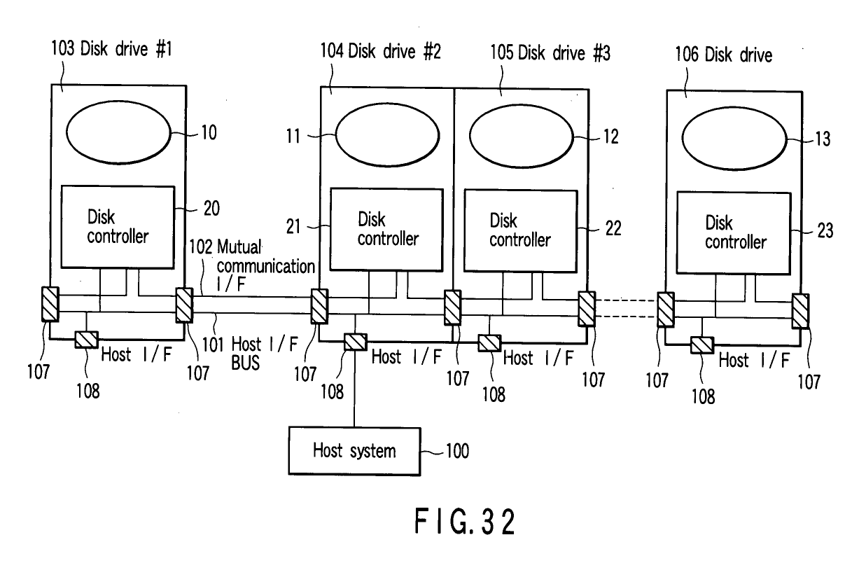

FIG. 32 is a block diagram showing the configuration of the RAID system according to a third embodiment.

In the third embodiment, the host interface bus 101 has the same bus structure as the first embodiment shown in FIG. 1. On the other hand, the communication between disk drives is conducted through the serial interface. The serial interface includes the signal lines such as transmission TX+, transmission TX−, reception RX+, and reception RX−. Namely, the system of the third embodiment adopts the method of conducting the communication between the disk drives by transmitting and receiving the information frame with the serial interface.

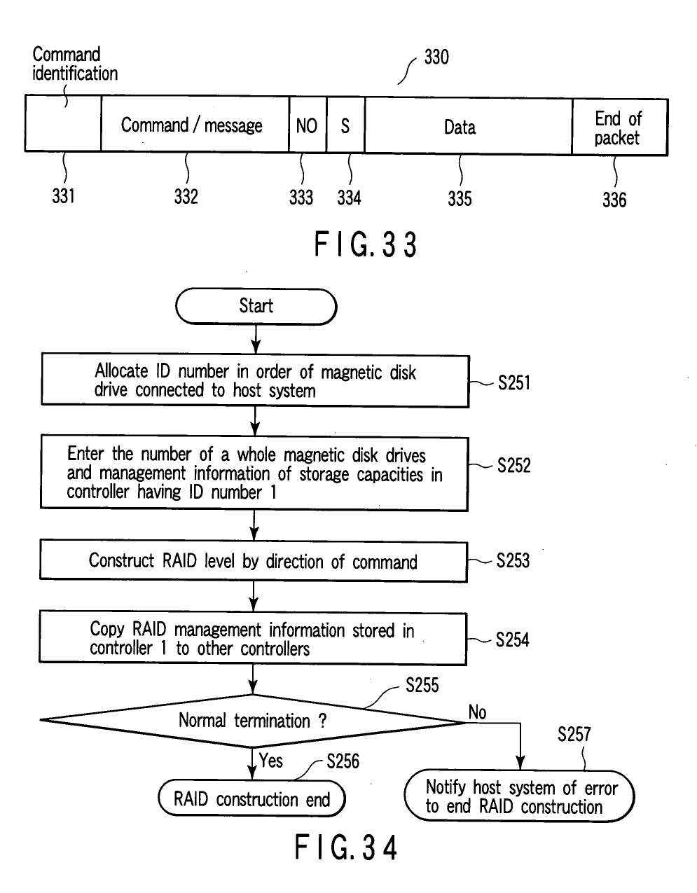

FIG. 33 shows a format of a packet 330 used in the communication between the disk drives in the third embodiment.

A front end portion 331 of the packet 330 is a command identifying portion which identifies whether the command is one in which the disk drive is controlled as the single disk drive by the host system or one in which the disk drive is controlled by the RAID system. Further, the format includes a command and message portion 332, a code portion 333 for specifying the disk controller number to be accessed, a data start portion 334, a data portion 335, and a portion 336 for indicating the end of the packet.

FIG. 34 is a flowchart showing a RAID constructing procedure according to the third embodiment.

Specifically, an ID (identification) number is allocated in the order of the disk drive connected to the host system 100 (Step S251). The disk controller (20) of the disk drive (#1) having the ID number 1 has management information such as the number of disk drives and the storage capacities of the disk drives in the RAID configuration (Step S252).

The disk controller 20 having the ID number 1 constructs RAID of the RAID level (for example, type 4 or type 5) specified by the command from the host system 100 (Step S253). The disk controller 20 having the ID number 1 copies its management data to the controllers of the other disk drives (Step S254).

When the above procedure is normally terminated, the RAID system constructing process is ended (Steps S255 and S256). When the above procedure is not normally terminated, the disk controller having the ID number 1 notifies the host system 100 of the error status, and the RAID system constructing process is ended (Step S257).

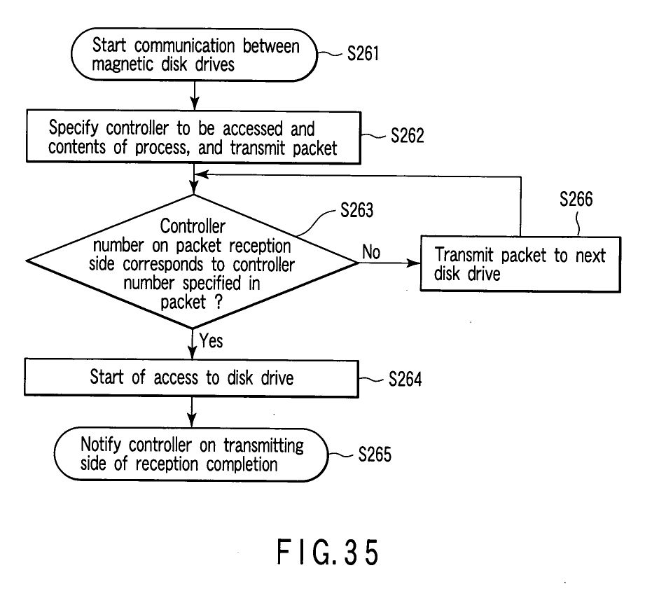

FIG. 35 is a flowchart showing a communication procedure between each of the disk drives according to the third embodiment.

The source disk controller 20 of the disk drive #1 specifies the destination disk controller number to transmit the packet (frame) (Step S261). The disk controller which receives the packet compares the destination disk controller number in the packet with the disk controller number of itself. If the destination disk controller number in the packet does not correspond to the disk controller number of itself, the disk controller which receives the packet transfers the packet to the adjacent disk drive (NO in Step S263 and Step S266).

If the destination disk controller number in the packet corresponds to the disk controller number of itself, the destination controller analyzes the received command to perform the process according to the command. Namely, disk access process is performed (YES in Step S263 and Step S264). The destination controller notifies the source controller 20 of the reception completion (Step S265).

As described above, according to the first to third embodiments, the disk drives which could operate as the stand-alone disk drive include the function of constructing the RAID system in collaboration with one another by the communication. Each disk drive can simply construct the RAID system at low cost based on the RAID system constructing command from the host system 100.

Namely, the RAID system can be realized with no dedicated controller such as the RAID controller by the configuration in which the RAID controller function is dispersed into disk drives.

Particularly, the plural small disk drives construct the RAID system in collaboration with one another by connecting the plural drives to one another so as to be able to mutually communicate with one another. Therefore, the RAID system having the high reliability and the large storage capacity can simply be constructed with no large-scale structure.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A disk drive comprising:
a drive mechanism which is operated as a single disk drive;
a communication unit which exchanges information for constructing a RAID system with other disk drives; and
a controller which exchanges information with other disk drives by using the communication unit, the controller realizing the RAID system by controlling the drive mechanism and drive mechanisms of other disk drives.

2. The disk drive according to claim 1, wherein the controller performs control operation for realizing the RAID system based on a constructing command which orders construction of the RAID system in commands received from a host system, and
the controller performs control operation for singularly operating the disk drive when the command is the command for operating as a single disk drive.

3. The disk drive according to claim 1, wherein the controller includes a RAID table to set each of a RAID type of the RAID system, group information for specifying the disk drives included in the RAID system, and flag information which enables a RAID function.

4. The disk drive according to claim 2, wherein the controller includes a RAID table to set each of a RAID type of the RAID system, group information for specifying the disk drives included in the RAID system, and flag information which enables a RAID function based on the constructing command received from the host system.

5. The disk drive according to claim 2, further comprising;
an interface which is used for both the case where the disk drive is singularly operated and the case where the RAID system is constructed.

6. The disk drive according to claim 1, wherein the controller includes a RAID structure table which is used for determination of a block structure with respect to address allocation of data or parity information in a RAID system configuration.

7. The disk drive according to claim 2, wherein the controller is configured to function as command response to the host system with respect to the construction of the RAID system or a transmitting end to other disk drive in response to a direction from the host system.

8. The disk drive according to claim 1, wherein the communication unit is a serial interface or a wireless communication unit.

9. A RAID system comprising:
a plurality of disk drives having drive mechanisms to be operated as a single disk drive;
a communication unit which exchanges information for constructing the RAID system among the disk drives; and
a plurality of controllers which exchange information with the other disk drives by using the communication unit, the controllers being respectively arranged in disk drives to realize a RAID controller in a dispersive manner.

10. The RAID system according to claim 9, wherein each of the controllers performs control operation for realizing the RAID system based on a constructing command which orders construction of the RAID system in commands received from a host system, and
the controller performs control operation for singularly operating the disk drive when the command is the command for singularly operating the disk drive.

11. A method of constructing a RAID system in a disk drive having a drive mechanism which functions as the single disk drive and a communication unit which exchanges information for constructing the RAID system with other disk drives, the method comprising:
receiving a RAID system constructing command from a host system;
exchanging the information with other disk drives by using the communication unit based on the RAID system constructing command; and
realizing the RAID system by controlling the drive mechanism and drive mechanisms of other disk drives.

12. The method according to claim 11, wherein the disk drive has a RAID processing table, and
each of a RAID type of the RAID system, group information for specifying the disk drives included in the RAID system, and a RAID table for each pieces of flag information which enables a RAID function is set in the RAID processing table.

13. The method according to claim 11, wherein the RAID processing table includes a RAID structure table which is used for determination of a block structure with respect to address allocation of data or parity information in a RAID system configuration.
